(19) United States
(12) Patent Application Publication
(10) Pub. No.: US 2011/0127949 A1
(43) Pub. Date: Jun. 2, 2011

(54) ELECTRONIC APPARATUS

(75) Inventor: Kinji TAKI, Ome-shi (JP)

(73) Assignee: KABUSHIKI KAISHA TOSHIBA, Tokyo (JP)

(21) Appl. No.: 12/957,252

(22) Filed: Nov. 30, 2010

(30) Foreign Application Priority Data
Nov. 30, 2009 (JP) 2009-272690

(51) Int. Cl. H02J 7/00

(52) U.S. Cl. 320/107

(57) ABSTRACT

According to one embodiment, an electronic apparatus includes a battery, a detection module, a setting module, and a charging module. The battery is configured to be chargeable by power from an external power supply. The detection module is configured to detect whether the battery is in a first charging state or a second charging state, a capacity of the second charging state is lower than the first charging state. The setting module is configured to set a charging end capacity of the second charging state, after passing of a preset period since the detection module detects that the battery is in the first charging state. The charging module is configured to charge the battery up to a capacity indicated by the charging end capacity.

### CROSS-REFERENCE TO RELATED APPLICATIONS

This application is based upon and claims the benefit of priority from Japanese Patent Application No. 2009-272690, filed Nov. 30, 2009; the entire contents of which are incorporated herein by reference.

### FIELD

Embodiments described herein relate generally to a battery-powerable electronic apparatus.

### BACKGROUND

Electronic apparatuses, which are configured to be portable, such as notebook PCs (personal computers), are equipped with chargeable batteries. When such an electronic apparatus is used in a stationary state, an AC adapter is connected to the electronic apparatus and power is received from an external power supply, and thereby the battery can be charged.

In usual cases, when the electronic apparatus is used with the AC adapter being connected at all times, the battery is always kept in a full-charged state (100% charged state). Consequently, the battery degrades earlier than in the case where the electronic apparatus is disconnected from the AC adapter and used by battery power.

Conventionally, there is known a battery charging method aiming at protecting the battery, which is attached to the electronic apparatus, from degradation. A battery charging method, which is disclosed in Jpn. Pat. Appln. KOKAI Publication No. H10-051968, is intended for electric cars. The degradation in battery capacity at the time of the full-charged state is suppressed by decreasing the amount of charge on a day of the week, before a day of the week on which the frequency of use of the battery is low, in accordance with the frequency of use, or by not charging the battery on a day of the week before a day on which the battery is expected to be left non-used.

As described above, in the prior art, the degradation of the battery is suppressed by avoiding the full-charged state of the battery by decreasing the amount of charge on a day of the week on which the frequency of use of the battery is low, or on a day of the week before a day of the week on which the frequency of use of the battery is low.

By adjusting the amount of charge on a day-by-day basis, the degradation of the battery due to long-time non-use in the full-charged state can be avoided. However, the amount of charge is decreased even in the case where the amount of charge on the day, on which the amount of charge is decreased, is not in the full-charged state. Thus, if the amount of charge of the battery is decreased on the preset day of the week in the state in which the amount of charge is initially small, the amount of charge of the battery would greatly decrease. It is possible that there periodically occur days on which the time in which battery-powered driving is enabled is short.

### BRIEF DESCRIPTION OF THE DRAWINGS

A general architecture that implements the various feature of the embodiments will now be described with reference to the drawings. The drawings and the associated descriptions are provided to illustrate the embodiments and not to limit the scope of the invention.

FIG. 1 is an exemplary external appearance view showing the structure of an electronic apparatus according to a first embodiment and a second embodiment;

FIG. 2 is an exemplary block diagram showing the system configuration of a personal computer in the first and second embodiments;

FIG. 3 is an exemplary diagram showing an example of data for a charging control of a battery in the first embodiment;

FIG. 4 is an exemplary diagram showing a variation of a charge capacity of the battery by the charging control in the first embodiment;

FIG. 5 is an exemplary flow chart illustrating the charging control operation of the battery in the first embodiment;

FIG. 6 is an exemplary flow chart illustrating a battery management utility process in the first embodiment;

FIG. 7 is an exemplary diagram showing an example of a setup screen for the battery management utility in the first embodiment;

FIG. 8 is an exemplary diagram showing an example of data for a charging control of a battery in the second embodiment;

FIG. 9 is an exemplary diagram showing a variation of a charge capacity of the battery by the charging control in the second embodiment;

FIG. 10 is an exemplary flow chart illustrating the charging control operation of the battery in the second embodiment; and

FIG. 11 is an exemplary flow chart for describing auto-setting of a charging end capacity in the first and second embodiments.

### DETAILED DESCRIPTION

Various embodiments will be described hereinafter with reference to the accompanying drawings.

In general, according to one embodiment, an electronic apparatus comprises a battery, a detection module, a setting module, and a charging module. The battery is configured to be chargeable by power from an external power supply. The detection module is configured to detect whether the battery is in a first charging state or a second charging state, a capacity of the second charging state is lower than the first charging state. The setting module is configured to set a charging end capacity of the second charging state, after passing of a preset period since the detection module detects that the battery is in the first charging state. The charging module is configured to charge the battery up to a capacity indicated by the charging end capacity.

Embodiments will now be described with reference to the accompanying drawings.

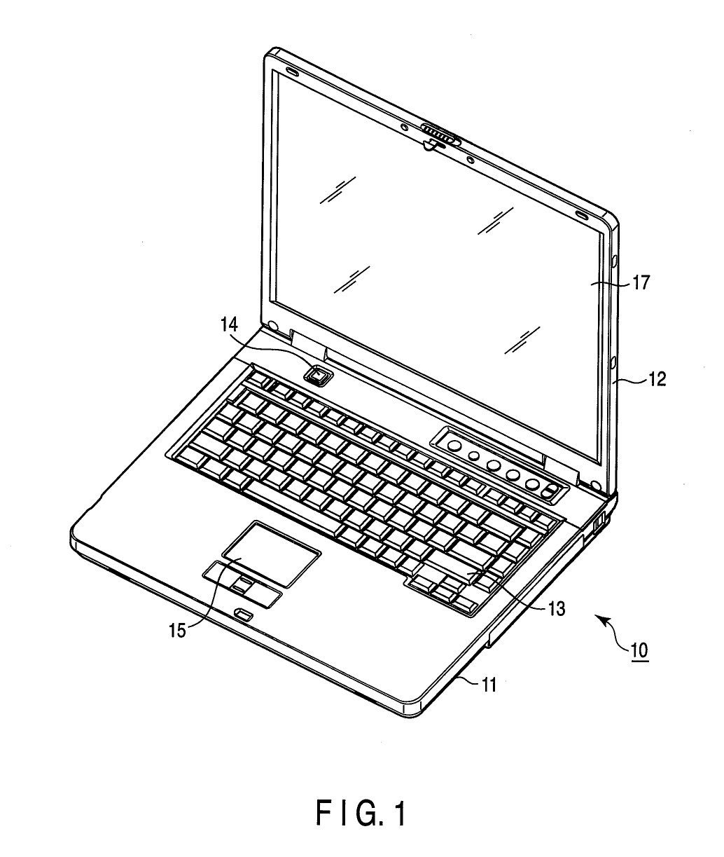

FIG. 1 is an external appearance view showing the structure of an electronic apparatus according to first and second embodiments. This electronic apparatus is realized, for example, as a notebook-type portable personal computer 10. The personal computer 10 in the embodiments can be driven not only by an external power supply (AC power supply), but also by a battery.

FIG. 1 is a perspective view showing the personal computer 10 in the state in which a display unit thereof is opened. The personal computer 10 comprises a computer main body 11 and a display unit 12. A display device that is composed of an LCD (Liquid Crystal Display) 17 is built in the display unit 12. A display screen of the LCD 17 is disposed at a substantially central part of the display unit 12.

The display unit 12 is attached to the computer main body 11 such that the display unit 12 is freely rotatable between an open position and a closed position. The computer main body 11 has a thin box-shaped casing to which a battery is detachably attached.

A keyboard 13, a power button switch 14 for power on/off, and a touch pad 15 are disposed on the top surface of the computer main body 11.

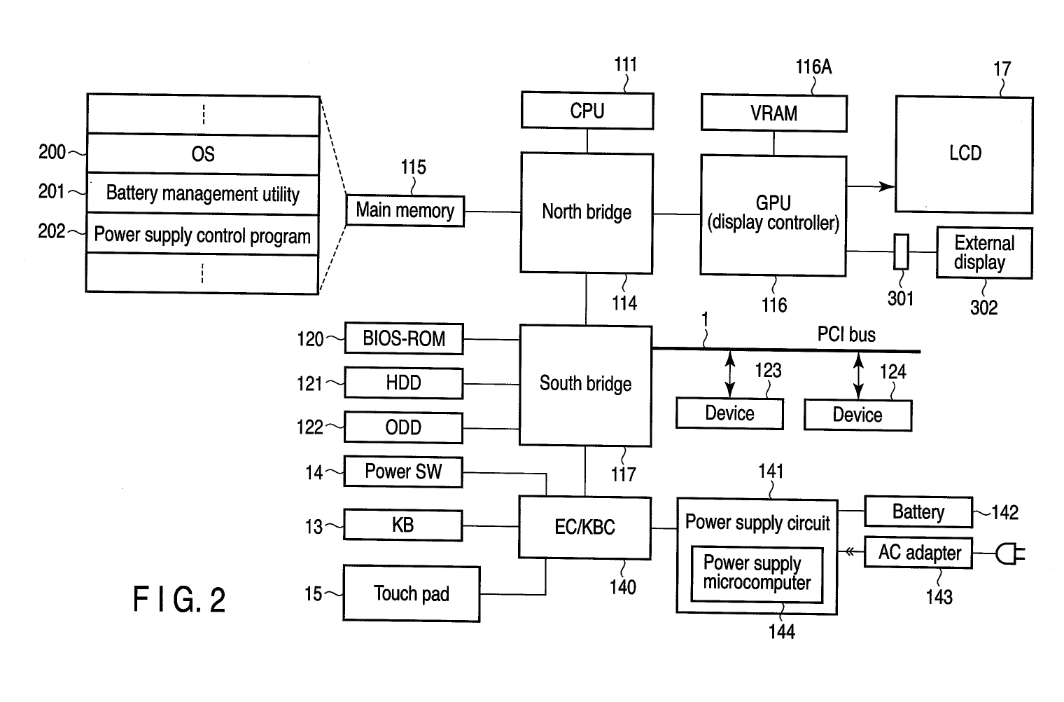

The computer main body 11 is configured such that a battery 142 (shown in FIG. 2) is detachably attached to, for example, a bottom part of the computer main body 11. In addition, a power connector (not shown) is provided on the computer main body 11, and an AC adapter 143 (shown in FIG. 2) can be connected to the power connector.

Next, referring to FIG. 2, the system configuration of the personal computer 10 in the first and second embodiments is described.

As shown in FIG. 2, the personal computer 10 comprises a CPU 111, a north bridge 114, a main memory 115, a graphics processing unit (GPU) 116, a south bridge 117, a BIOS-ROM 120, a hard disk drive (HDD) 121, an optical disc drive (ODD) 122, various PCI devices 123 and 124, an embedded controller/keyboard controller IC (EC/KBC) 140, and a power supply circuit 141.

The CPU 111 is a processor which is provided in order to control the operation of the personal computer 10. The CPU 111 executes an operating system (OS) 200 and various application programs, which are loaded from the HDD 121 into the main memory 115. In addition, the CPU 111 executes a battery management utility program 201 for executing various settings relating to the battery 142, and a power supply control program 202 for executing power supply control.

Further, the CPU 111 also executes a system BIOS (Basic Input/Output System) which is stored in the BIOS-ROM 120. The system BIOS is a program for hardware control.

The north bridge 114 is a bridge device which connects a local bus of the CPU 111 and the south bridge 117. The north bridge 114 includes a memory controller which access-controls the main memory 115.

The GPU 116 is a display controller for controlling the LCD 17 which is used as a display monitor of the personal computer 10, and an external display 302 such as a CRT. The external display 302 is connected, where necessary, to an external video output terminal 301 which is provided on the computer main body 11.

The GPU 116 executes a display process (graphics arithmetic process) for drawing frames on the video memory (VRAM) 116A, on the basis of a drawing request which is sent from CPU 111 via the north bridge 114.

The south bridge 117 is connected to a PCI bus 1, and executes communication with the PCI devices 123 and 124 via the PCI bus 1.

The south bridge 117 incorporates an IDE (Integrated Drive Electronics) controller and a Serial ATA controller for controlling the HDD 121 and optical disc drive (ODD) 122.

The embedded controller/keyboard controller IC (EC/KBC) 140 is a 1-chip microcomputer in which an embedded controller for power management and a keyboard controller for controlling the keyboard (KB) 13 and touch pad 15 are integrated. The EC/KBC 140 has a function of powering on/off the personal computer 10 in response to the user's operation of the power button switch 14. The power-on/off control of the personal computer 10 is executed by the cooperation between the EC/KBC 140 and power supply circuit 141.

The power supply circuit 141 generates operation power to the respective components by using power from the battery 142 which is attached to the computer main body 11, or power from an external power supply which is connected via the AC adapter 143. The power supply circuit 141 is provided with a power supply microcomputer 144. The power supply microcomputer 144 monitors the power supply (charge/discharge) to the respective components and battery 142, and the charging state (charging capacity (voltage)) of the battery 142. When the battery 142 and AC adapter 143 are connected, the power supply circuit 141 charges the battery 142 by the external power supply.

### First Embodiment

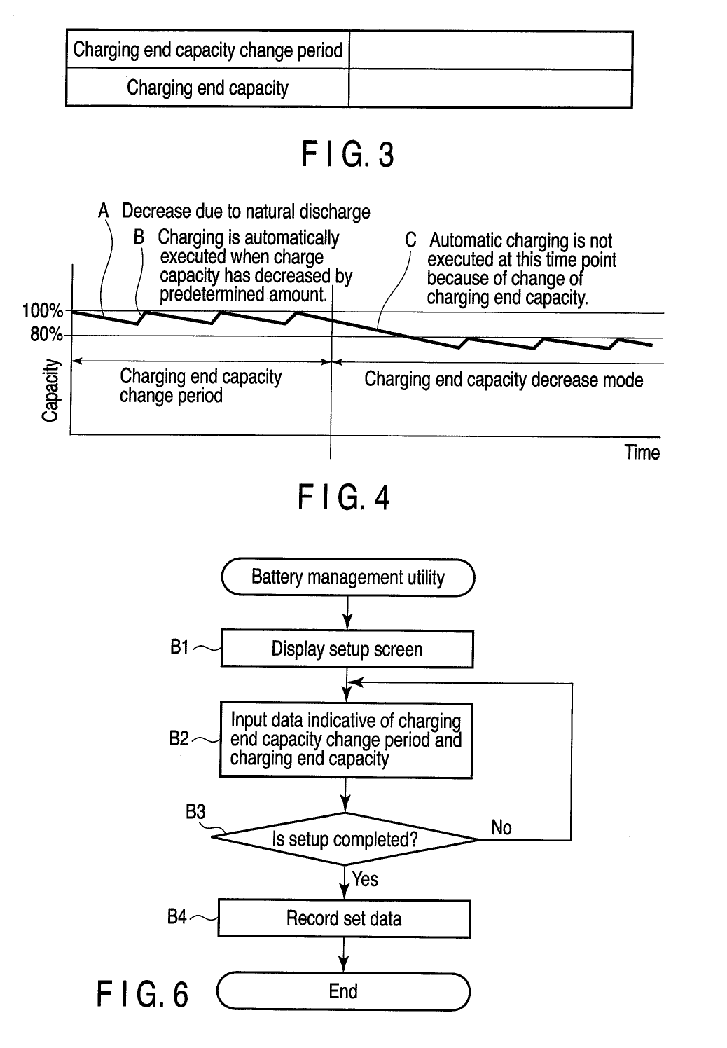

In the first embodiment, in order to execute charging control of the battery 142, as shown in FIG. 3, data indicative of a charging end capacity change period and a charging end capacity is set. This data is stored, for example, in the EC/KBC 140 or in the power supply microcomputer 144.

FIG. 4 shows a variation of a charge capacity of the battery 142 by the charging control in the first embodiment.

As shown in FIG. 4, the charging end capacity change period is indicative of a period for transitioning to a charging end capacity decrease mode after it is determined that the battery 142 is in a full-charged state, based on the charging end capacity in the initial state. The charging end capacity change period is preset at an initial value (default value). The charging end capacity change period is designated, for example, by an hour unit, a day unit, or a month unit. The charging end capacity decrease mode is a state in which the charging end capacity is changed to less than 100%.

The charging end capacity is a reference capacity at which the battery 142 is determined to be in the full-charged state. The charging end capacity is set at a 100% charged state in the initial state (default value). When a transition occurs to the charging end capacity decrease mode, the charging end capacity is set at a value lower than in the initial state. For example, in FIG. 4, the charging end capacity in the charging end capacity decrease mode is set at 80% which is preset. The lower limit of the charging end capacity is set at, e.g. a value at which the battery 142 does not degrade due to over-discharge (the lower limit varies depending on the capability of the battery 142). Accordingly, the charging end capacity is set in the range between the default value (100% charging state) and the lower limit value.

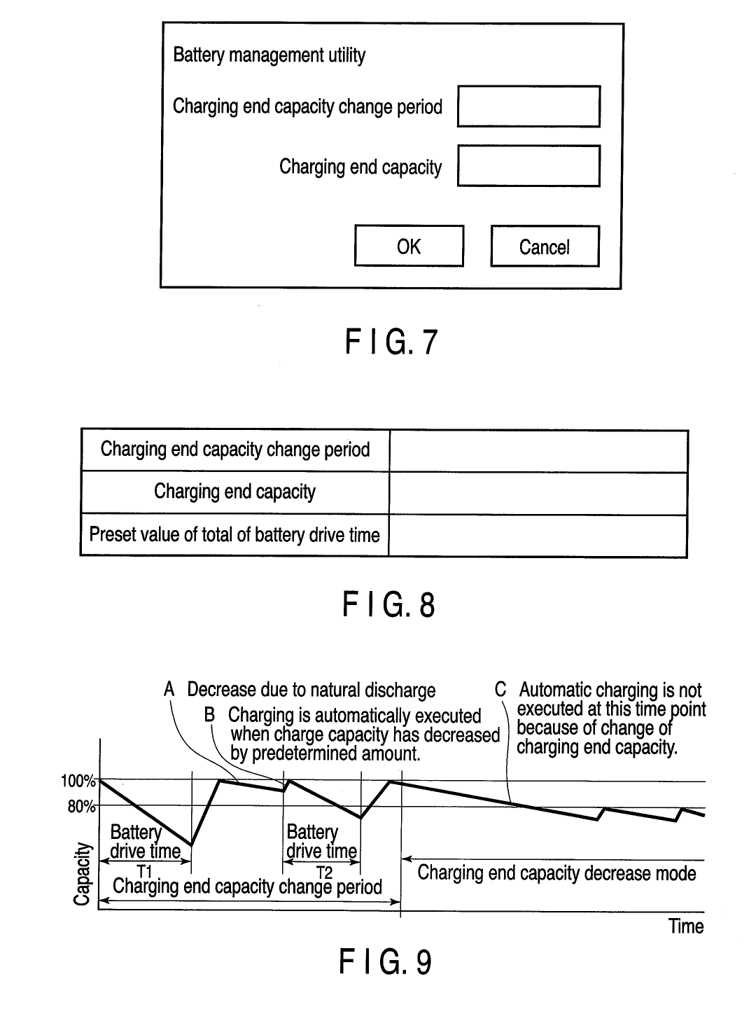

The charging end capacity change period and the charging end capacity can arbitrarily be varied according to designation by the user, by a battery management utility (to be described later). The details will be described later (FIG. 6, FIG. 7).

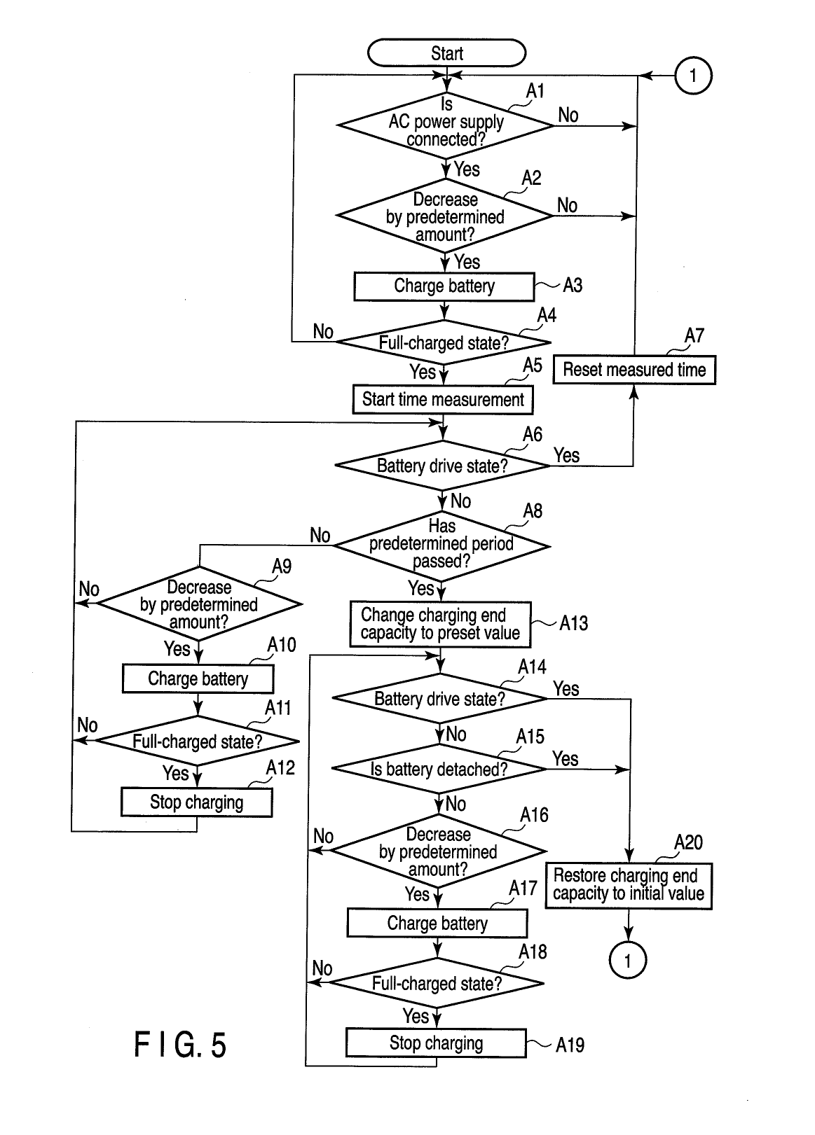

Next, referring to a flow chart of FIG. 5, a description is given of the charging control operation of the battery 142 in the first embodiment.

When the AC adapter 143 is connected (AC adapter drive state) and external power is supplied (Yes in block A1), the power supply circuit 141 charges the battery 142. If the charge capacity of the battery 142, which is detected by the power supply microcomputer 144, has decreased by a predetermined amount from the full-charged state (Yes in block A2), the power supply circuit 141 continues charging the battery 142 (block A3). Thus, if the AC adapter 143 is connected, the power supply circuit 141 continues charging until the battery 142 comes to the full-charged state.

The “predetermined amount”, mentioned above, is a reference value for determining the charge capacity which has decreased due to natural discharge of the battery 142. As indicated by A in FIG. 4, when the charge capacity of the battery 142 has decreased by the predetermined amount due to natural discharge from the full-charged state (Yes in block A2), the power supply circuit 141 charges the battery 142, as indicated by B in FIG. 4 (block A3).

If it is determined that the battery 142 has come to the full-charged state (100% charge state of the initial value) (Yes in block A4), the power supply circuit 141 starts time measurement in order to discriminate the passage of the charging end capacity change period (block A5). The time measurement is continued until the AC adapter 143 is disconnected and a transition is made to the battery drive state in which driving by the battery 142 is performed. If a transition is made to the battery drive state (Yes in block A6), the measured time is reset (block A7).

On the other hand, if no transition is made to the battery drive state (No in block A6), the charge capacity of the battery 142 has decreased by a predetermined amount due to natural discharge (Yes in block A9, the power supply circuit 141 automatically charges the battery 142 (block A10). If the battery 142 has come to the full-charged state, the charging is stopped (block A12). Subsequently, similarly, in the case where no transition is made to the battery drive state (No in block A6), if the charge capacity of the battery 142 has decreased by a predetermined amount due to natural discharge (Yes in block A9), the battery 142 is automatically charged and kept in the full-charged state (block A10).

If a predetermined time indicated by the charging end capacity change period has passed since the battery 142 was determined to be in the full-charged state (Yes in block A8), the power supply circuit 141 changes the present charging end capacity (the initial value is the 100% charged state) to a preset value (block A13) and makes a transition to the charging end capacity decrease mode. In this case, it is assumed that the charging end capacity in the charging end capacity decrease mode is set at, e.g. an 80% charged state.

The power supply circuit 141 changes the charging end capacity, based on a set value stored in the power supply microcomputer 144, or a set value read from the EC/KBC 140 in the case where the set value is stored in the EC/KBC 140.

In the charging end capacity decrease mode, the charging end capacity is decreased. Thus, the power supply circuit 141 does not charge the battery 142 in a time period C indicated in FIG. 4, that is, in a time period until the charge capacity has decreased by a predetermined amount from the newly set charging end capacity due to natural discharge (No in block A16).

If the charge capacity has decreased by a predetermined amount from the newly set charging end capacity (80% charged state) due to natural discharge (Yes in block A16), the power supply circuit 141 charges the battery 142 in the same manner as described above (block A17). Specifically, if the battery 142 is charged up to the 80% charged state, the power supply circuit 141 determines that the battery 142 is in the full-charged state (Yes in block A18) and stops the charging (block A19).

Subsequently, if no transition is made to the battery drive state or if the battery 142 is not detached from the computer main body 11 (No in block A14, No in block A15), the battery 142 is repeatedly charged up to the full-charged state (80% charged state) each time the charge capacity of the battery 142 has decreased by the predetermined amount due to natural discharge, and the battery 142 is kept in the full-charged state (blocks A16 to A19).

Specifically, in the charging end capacity decrease mode, even if the AC adapter 143 is connected and the external power is supplied for a long time, the battery 142 does not become in the 100% charged state, and it becomes possible to avoid degradation of the battery 142. Therefore, the life of the battery 142 can be elongated.

On the other hand, if a transition is made from the AC adapter drive state to the battery drive state (Yes in block A14) or if the battery 142 is detached from the computer main body 11 (Yes in block A15), the power supply circuit 141 increases the charging end capacity. For example, the power supply circuit 141 restores the charging end capacity to the 100% charged state of the initial value (block A20). In the meantime, in the case of increasing the charging end capacity, it is not necessary to increase the charging end capacity to the 100% charged state of the initial value.

By increasing the charging end capacity in this manner, the charge capacity, which has been consumed by the battery drive, can be recovered by recharging the battery 142 when the battery 142 is attached and the driving by the AC adapter is started once again. If the charging end capacity change period has passed since the battery 142 came to the full-charged state, the charging end capacity is decreased to a preset value in the same manner as described above. Thereby, the degradation of the battery 142 due to long-time continuation of the 100% charged state is avoided.

When the battery 142 is detached from the computer main body 11, it is possible that another battery 142 is attached for replacement. Thus, the charging end capacity is restored to the initial value so that the charging can be performed up to the 100% charged state.

In the above description, when a transition is made from the AC adapter drive state to the battery drive state or when the battery 142 is detached from the computer main body 11, the charging end capacity is increased (restored to the initial value). Alternatively, the charging end capacity may be restored to the initial value at other timing. For example, when the AC adapter 143 is connected (AC adapter drive stat) after the end of the battery drive, the charging end capacity may be restored to the initial value.

As has been described above, in the first embodiment, in the case where the charging end capacity change period has passed since the detection of the full-charged state (100% charged state of the initial value) of the battery 142, that is, in the case where the 100% charged state of the battery 142 has continued for a long time, the charging end capacity is lowered from the initial value and the charging is performed only up to the newly set charging end capacity. Thereby, the degradation of the battery 142 can be avoided.

In the charging end capacity decrease mode, the battery 142 is not in the 100% charged state. If the personal computer 10 is driven by battery in this state, the battery drive time is short. However, since the charging end capacity is restored to the initial state, the charging is then performed up to the normal charging end capacity (100% charged state) and the battery drive time can be increased.

In the above description, after it is detected that the battery 142 is in the full-charged state, the capacity, which has decreased due to natural discharged, is automatically charged and the full-charged state is kept. Instead of automatically charging the battery 142, it is possible to lower the charging end capacity after the passing of a predetermined period since the first detection of the full-charged state of the battery 142.

Next, a battery management utility process is described with reference to a flow chart shown in FIG. 6.

If execution of a battery management utility is instructed by the user, the CPU 111 activates the battery management utility program 201 and starts the battery management utility process.

Based on the battery management utility program 201, the CPU 111 causes the LCD 17 to display a setup screen for the battery management utility (block B1).

FIG. 7 shows an example of the setup screen for the battery management utility.

As shown in FIG. 7, input fields are provided for the user to input arbitrary designation values for the charging end capacity change period and the charging end capacity.

For example, by the user's operation of the keyboard 13, the CPU 111 inputs data indicative of the charging end capacity change period and the charging end capacity (block B2). The charging end capacity change period can be designated, for example, by an hour unit, a day unit, a week unit or a month unit. The charging end capacity can arbitrarily be set, for example, at a value in a preset range (e.g. 50% to 90%).

If setup completion is instructed by the selection of “OK” on the setup screen (Yes in block B3), the CPU 111 records the data, which has been set for the charging end capacity change period and the charging end capacity, in a nonvolatile memory, for instance, in the EC/KBC 140 or in the power supply circuit 141 (power supply microcomputer 144) via the EC/KBC 140 (block B4). In the meantime, such data may be stored in the HDD 121 and may be read out by the EC/KBC 140 or power supply microcomputer 144.

In this manner, by using the battery management utility, the user can arbitrarily designate the charging end capacity change period and the charging end capacity, which are used for the charging control of the battery. Thereby, according to how the user is using the personal computer 10, the proper charging end capacity change period and charging end capacity can be set, the degradation of the battery can be avoided, and a sufficient charge capacity that is necessary for battery drive can be secured.

The charging end capacity, which is set at the time of the charging end capacity decrease mode, is set at a value lower than the initial state (100% charged state), in order to avoid degradation of the battery 142. Thus, if the AC adapter 143 is detached from the personal computer 10, which is in the charging end capacity decrease mode, and the personal computer 10 is driven by battery, the battery drive time becomes shorter than in the case where the battery 142 is charged up to the charging end capacity of the initial state. However, in the case where the user drives the personal computer 10 by battery, if a long-time use is scheduled, the charging end capacity is set at a relatively high value, e.g. 90%, and thereby the long-time battery drive is enabled. If the use by battery drive is not scheduled, the charging end capacity may be set at a relatively low value, e.g. 50%.

### Second Embodiment

In the first embodiment, a transition occurs to the charging end capacity decrease mode in the case where the charging end capacity change period has passed, without battery drive, since the detection of the full-charged state (100% charged state of the initial value) of the battery 142. In a second embodiment, if the total of the battery drive time in the charging end capacity change period is a preset value or less, a transition occurs to the charging end capacity decrease mode. Specifically, if the time of battery drive of the personal computer 10 in a predetermined time period (charging end capacity change period) is short, the charging end capacity is lowered to below the initial value, as in the first embodiment. Thereby, degradation of the battery 142 is avoided.

In the second embodiment, in order to execute charging control of the battery 142, as shown in FIG. 8, data indicative of a charging end capacity change period, a charging end capacity and a set value for the total of battery drive time (hereinafter referred to as “total set value”) is set. This data is stored, for example, in the EC/KBC 140 or in the power supply microcomputer 144.

FIG. 9 shows a variation of the charge capacity of the battery 142 by the charging control in the second embodiment.

A description overlapping with the description of the first embodiment is omitted below.

As shown in FIG. 9, the charging end capacity change time is indicative of the period from when the full-charged state of the battery 142 is determined based on the charging end capacity of the initial state to when the transition to the charging end capacity decrease mode is determined. The total set value is a set value for the total of the time in the charging end capacity change period, in which the battery drive is performed. If the total of the battery drive time in the charging end capacity change period is the total set value or less, a transition occurs to the charging end capacity decrease mode.

In the meantime, the charging end capacity change period, charging end capacity and total set value can arbitrarily be varied by the battery management utility in accordance with the designation by the user.

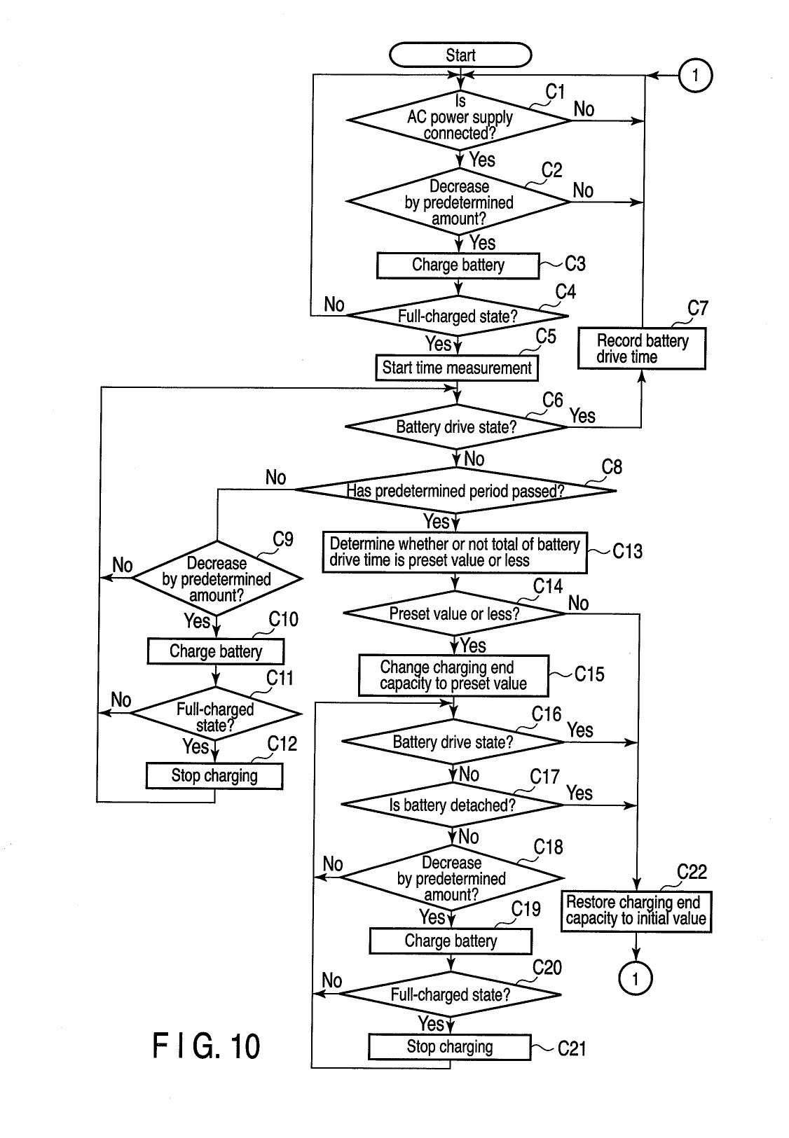

Next, referring to a flow chart of FIG. 10, a description is given of the operation of charging control of the battery 142 in the second embodiment.

In FIG. 10, the description of blocks C1 to C12 is omitted since basically the same process as in blocks A1 to A12 shown in FIG. 5 in the first embodiment is executed in blocks C1 to C12.

However, in the second embodiment, in the case where the battery drive is performed in the charging end capacity change period, the power supply circuit 141 (power supply microcomputer 144) records the battery drive time (block C7). When the battery drive is performed twice or more, the power supply circuit 141 calculates and records the total of the battery drive time.

In the example shown in FIG. 9, the battery drive is executed twice in the charging end capacity change period. Thus, the power supply microcomputer 144 calculates and records the total (T1+T2) of a first battery drive time T1 and a second battery drive time T2.

If the charging end capacity change period has passed (Yes in block C8), the power supply circuit 141 determines whether the total of the battery drive time is a preset total set value or less (block C13).

If the total of the battery drive time is not a preset total set value or less (No in block C13), the power supply circuit 141 continues the normal charging control, without a transition to the charging end capacity decrease mode (blocks C1 to C12).

On the other hand, if the total of the battery drive time is a preset total set value or less (Yes in block C14), the power supply circuit 141 changes the present charging end capacity (the initial value is the 100% charged state) to a preset value (block C15) and makes a transition to the charging end capacity decrease mode. In this case, it is assumed that the charging end capacity in the charging end capacity decrease mode is set at, e.g. a value corresponding to an 80% charged state.

A description of blocks C15 to C22 following the transition to the charging end capacity decrease mode is omitted, since basically the same process as in blocks A13 to A20 shown in FIG. 5 in the first embodiment is executed in blocks C15 to C22.

As described above, in the second embodiment, in the case where the total of the battery drive time during the time period, from a time when the full-charged state (100% charged state of the initial value) of the battery 142 is detected to a time when the charging end capacity change period is terminated, is the preset total set value or less, a transition occurs to the charging end capacity decrease mode. In the charging end capacity decrease mode, the charging end capacity is lowered to below the initial value, and the charging is performed only up to the newly set charging end capacity. Thereby, the degradation of the battery 142 is avoided. Specifically, in the case where the time of use by the battery drive is short, it is determined that there is no problem with the use by the battery drive even if the charging end capacity is lowered to below the initial value and the charge capacity is decreased. Thereby, priority is placed on the protection of the battery 142.

Also in the second embodiment, it is possible to execute the battery management utility process which has been described in the first embodiment. In the second embodiment, not only the charging end capacity change period and charging end capacity but also the total set value can be set by the user's designation.

In the second embodiment, the total set value may be set by the ratio to the charging end capacity change period. Specifically, it is possible to determine whether or not to transition to the charging end capacity decrease mode, according to the ratio of the time of battery drive to the charging end capacity change period. In this case, such configuration is adopted that the ratio of the time of battery drive to the charging end capacity change period can arbitrarily be designated by the user.

In the above description, the total of the battery drive time during the charging end capacity change period is calculated. Alternatively, the total of the charge capacity, which has decreased due to battery drive, may be calculated. Specifically, even if the drive time is the same, the decrease in charge capacity of the battery 142 varies depending on the process content at the time of the battery drive. Thus, based on the charge capacity which has decreased due to battery drive, it is determined whether or not to transition to the charging end capacity decrease mode. In this case, the total set value is the data which is indicative of the charge capacity.

In the first embodiment and second embodiment, the charging end capacity can arbitrarily be set by the user by the battery management utility process. Alternatively, the charging end capacity can automatically be set on the basis of the condition of use of the personal computer 10 by battery drive.

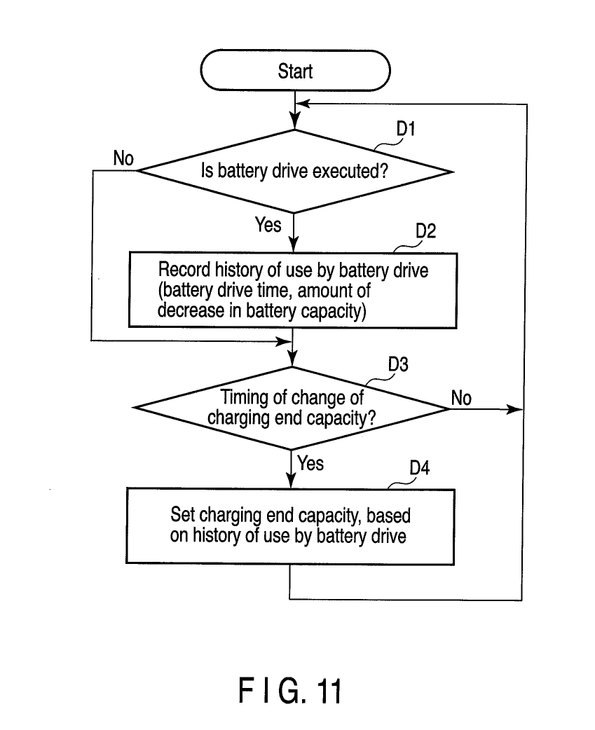

FIG. 11 is a flow chart for describing auto-setting of the charging end capacity. The auto-setting of the charging end capacity is executed, for example, by the power supply control program 202.

The CPU 111 monitors, by the power supply control program 202, whether the personal computer 10 is in the AC adapter drive state or in the battery drive state. At the time of the battery drive state (Yes in block D1), the history of use by the battery drive is recorded, for example, in the HDD 121 (block D2). The history of use includes, for example, the battery drive time (start time, end time) and the amount of decease of the charge capacity of the battery 142.

If there comes a timing of change of the charging end capacity, the CPU 111 sets the charging end capacity, based on the history of use by the battery drive which is recorded in the HDD 121 (block D4). For example, the timing of change of the charging end capacity is a predetermined time interval, such as every month.

For example, if it is determined, from the history of use, that the time of use by single-time battery drive is long, the charging end capacity is set at a high value (e.g. 90%) so that there occurs no problem even if a transition occurs to the battery drive from the charging end capacity decrease mode.

In addition, even if the frequency of use of battery drive is high, the value of the charging end capacity is lowered in the case where the single-time battery drive time is short, and the charge amount of the battery 142 is decreased. Thereby, the degradation of the battery 142 is avoided.

Besides, based on the history of use, the charging end capacity can be set at a proper value so that no problem occurs with the use by battery drive due to the decrease of the charging end capacity.

In the meantime, the history of use may be set with respect to not only the charging end capacity, but also the charging end capacity change period or total set value (second embodiment).

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic apparatus comprising:
a battery configured to receive power from an external power supply;
a detection module configured to detect whether the battery is in a first charging state or a second charging state, where a capacity of the second charging state is lower than the first charging state;
a setting module configured to set a charging end capacity of the second charging state, after a lapse of a preset period since the detection module detects that the battery is in the first charging state; and
a charging module configured to charge the battery up to a capacity indicated by the charging end capacity.

2. The electronic apparatus of claim 1, wherein the setting module is configured to set the charging end capacity when a transition occurs to a battery drive state, in which driving by the battery is executed, after the lapse of the preset period.

3. The electronic apparatus of claim 1, further comprising:
an input module configured to input data indicative of the preset period and the charging end capacity; and
a storing module configured to store the data.

4. The electronic apparatus of claim 1, further comprising:
a history recording module configured to record a history of a usage in a battery drive state,
wherein the setting module is configured to set the charging end capacity, based on the history of the usage.

5. An electronic apparatus comprising:
a battery configured to receive by power from the external power supply;
a detection module configured to detect whether the battery is in a first charging state or a second charging state, where a capacity of the second charging state is lower than the first charging state;
a calculation module configured to calculate a total of a time of a battery drive state, in which driving by the battery is executed, prior to a lapse of a preset period since the detection module detects that the battery is in the first charging state;
a setting module configured to set a charging end capacity of the second state, when the total of the time, which is calculated by the calculation module, is a preset value or less; and
a charging module configured to charge the battery up to a capacity indicated by the charging end capacity.

6. The electronic apparatus of claim 5, wherein the setting module is configured to increase the charging end capacity when a transition occurs to a battery drive state after the lapse of the preset period.

7. The electronic apparatus of claim 5, further comprising:
an input module configured to input data indicative of the preset period, the charging end capacity and the preset value; and
a storing module configured to store the data.

8. The electronic apparatus of claim 5, further comprising:
a history recording module configured to record a history of a usage in the battery drive state,
wherein the setting module is configured to set the charging end capacity, based on the history of the usage.
